(19) United States
(12) Patent Application Publication
(10) Pub. No.: US 2006/0194002 A1
(43) Pub. Date: Aug. 31, 2006

(54) Butterfly wing lamination process and method of use

(76) Inventor: Michael Soukup, Severn, MD (US)

Correspondence Address: Law Offices of Royal W. Craig, 10 N. Calvert Street, Suite153, Baltimore, MD, 21202, US

(21) Appl. No.: 10/559,895

(22) PCT Filed: Jun. 4, 2004
(86) PCT No.: PCT/US04/17851

§ 371 Date: Dec. 6, 2005

Related U.S. Application Data
(60) Provisional application No. 60/476,453, filed on Jun. 6, 2003.

(51) Int. Cl. A01N 1/00; B32B 37/00

(52) U.S. Cl. 428/16; 156/253; 156/278; 427/407.1

(57) ABSTRACT

A multi-layer lamination process for butterfly wings to facilitate their use in jewelry, accessories, gift items, crafts, etc. The process steps include (1) the mixing of a liquid epoxy resin, (2) application of a layer of the liquid epoxy resin to a sheet of Mylar® (3) affixing a butterfly wing to the liquid epoxy resin/Mylar® sheet combination, (4) allowing the layer of liquid epoxy resin to dry, (5) applying a layer of fixative to the exposed side of the butterfly wing, (6) allowing the layer of fixative to dry, (7) applying a first layer of clear lacquer/resin over the fixative, (8) allowing the first layer of lacquer/resin to dry, (9) cutting along the outer perimeter of the butterfly wing to separate the wing from the remainder of the Mylar® sheet, (10) smoothing the edges of the cut-out butterfly wing, (11) the application of a second layer of clear lacquer/resin over the first layer, (12) allowing the second layer of lacquer/resin to dry, (13) applying a third layer of clear lacquer/resin over the second layer, and (14) allowing the third layer of lacquer/resin to dry. In addition, a hole may be drilled through one end of the laminated butterfly wing, and a bail affixed to the hole for jewelry design. The process results in a multi-layered lamination that strengthens and preserves the wing's naturally occurring colors and patterns.

### TECHNICAL FIELD

The present invention relates to lamination processes and, more particularly, to a process for laminating butterfly wings, and even more particularly, to the use of laminated butterfly wings in a variety of jewelry, crafts, accessories, gift items, and objects of art.

### BACKGROUND ART

Butterfly wings are a beautiful phenomenon of nature. They have many shapes, sizes, colors, and patterns. The large variety of natural vibrant colors and intricate patterns are nature's unique works of art. People have long enjoyed gazing at butterflies, collecting, photographing, and drawing them. However, the butterfly wing is extremely fragile and not easily preserved. In the past, amateur collectors have pressed butterfly wings between waxed paper, or stored them in boxes or scrap books or the like. Unfortunately, these crude methods do not preserve the natural beauty of the wings. More advanced methods of preservation, such as encasing the butterfly wings in wax or airtight acrylic cases, have developed. However, none of these prior methods preserve the natural beauty of the butterfly wings, while allowing them to be used in a decorative or artistic manner. The wings are too fragile to be used without being subjected to some form of strengthening and/or preservation. Butterfly wings are covered by tiny “scales” that are very similar to those found on fish. The scales provide the colors and patterns for the wings. However, the scales are easily removed when the wings are rubbed (i.e. resulting in the “dust” that is generated by the handling of butterfly wings). If used in jewelry, crafts, accessories, other gift items, or objects of art without some process for preservation, the colors/patterns would be easily and quickly removed during normal handling.

Traditional jewelry is typically fabricated of one or more precious metals (e.g. silver, gold, platinum), or the combination of one or more precious metals and one or more precious minerals/stones such as diamonds, sapphires, rubies, etc. The combination and final shape/configuration of the metals and minerals/stones are generally chosen with the intention of providing the jewelry with a significant degree of visual appeal. The process of jewelry design has resulted in thousands of shape and color combinations

Many of the man-made combinations of shapes and colors found in jewelry designs are intended to mimic, or replicate, an object found in nature. While many naturally occurring objects can only be mimicked because they are physically too large or heavy for actual use in jewelry, one type of object that could actually be utilized in jewelry design/construction is the butterfly wing. Butterfly wings are not too large or too heavy, and are available in a variety of striking shapes, colors, and patterns.

As butterfly wings are beautiful creations of nature, if properly preserved, they can be used in a wide variety of decorative applications in addition to jewelry designs. For example, a butterfly wing can be attached to a hair pin to create a lovely hair accessory, or to a belt to create a clothing accessory. The wing may be integrated with an artificial flower arrangement, encased in glass, or stand-alone. Several wings may be arranged together to create a piece of artwork. There are any number of uses for beautiful preserved butterfly wings.

To the best of the knowledge of the present inventor, no prior method for the strengthening/preservation of butterfly wings, for the purpose of using them in various jewelry, accessory, gift items, other craft designs, and objects of art exists. Consequently, it would thus be greatly advantageous to provide a lamination process that (1) preserves the naturally occurring colors and patterns found in live butterfly wings, (2) results in a strong, durable finished good that may be incorporated in the design and manufacture of jewelry, accessories, craftwork, and other gift items, that may be worn externally on the body or displayed for viewing, and exposed to a wide variety of environments and weather conditions, and (3) is readily and economically performed to provide for repeated use.

### DISCLOSURE OF THE INVENTION

It is, therefore, the primary object of the present invention to provide a process for the lamination of butterfly wings for the purpose of strengthening/preserving them to facilitate their use in the design and construction of jewelry, accessories, gift items, other crafts, and objects of art.

A further object of the present invention is to provide a process for the lamination of butterfly wings that preserves the naturally occurring colors and patterns.

It is another object of the present invention to provide a process for the lamination of butterfly wings that uses strong, durable, lightweight materials.

It is yet another object of the present invention to provide a process for lamination of butterfly wings that may be used in any number of jewelry, accessory, gift item, craft designs, and objects of art.

It is still another object of the present invention to provide a process for lamination of butterfly wings that allows the wings to be easily cleaned.

An additional object of the present invention is to provide a process for the lamination of butterfly wings that is readily and economically performed to provide for repeated use.

According to the present invention, the above-described and other objects are accomplished by a multi-layer lamination process typically comprising a series of fourteen steps and the use of at least four materials/mixtures. The process steps include (1) the mixing of a liquid epoxy resin, (2) the application of a layer of the liquid epoxy resin to a sheet of thin smooth material, such as a polyester film or Mylar®, (3) affixing a butterfly wing to the liquid epoxy resin sheet combination, (4) allowing the layer of liquid epoxy resin to dry, (5) applying a layer of fixative to the exposed side of the butterfly wing, (6) allowing the layer of fixative to dry, (7) applying a first finish coat of clear lacquer/resin over the fixative, (8) allowing the first finish coat of lacquer/resin to dry, (9) cutting along the outer perimeter of the butterfly wing to separate the wing from the remainder of the sheet, (10) smoothing the edges of the cut-out butterfly wing, (11) applying a second finish coat of clear lacquer/resin over the first layer, (12) allowing the second finish coat of lacquer/resin to dry, (13) applying a third finish coat of clear lacquer/resin over the second layer, and (14) allowing the third finish coat of lacquer/resin to dry. An alternative embodiment, utilized with extremely fragile butterfly wing variations, adds two steps prior to step (1) above. These additional steps include (a) the affixing of a butterfly wing to a first sheet of self-adhesive, ultra-thin material, such as Mylar® and (b) the affixing of a second sheet of self-adhesive, ultra-thin material onto the exposed side of the butterfly wing. The above processes for the lamination of butterfly wings use strong, durable, lightweight materials and may be readily and economically performed to provide for repeated use. When utilized in conjunction with a butterfly wing, the process results in a multi-layered lamination that strengthens and preserves the wing's naturally occurring colors and patterns, which allows the wings to be used in various jewelry, accessory, gift item, craft, and object of art designs. To create jewelry with a laminated butterfly wing, two additional processing steps are required: (1) the drilling of a hole through one end of the laminated butterfly wing, and (2) the affixing of a bail to the hole.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a top perspective view of a laminated butterfly wing 10, 50 of the present invention.

FIG. 2 is a top perspective view of a second embodiment of a laminated butterfly wing 10, 50 of the present invention.

FIG. 3 is a flow diagram of the laminated butterfly wing process of the present invention.

FIG. 4 is a flow diagram of a second embodiment of the laminated butterfly wing process of the present invention.

FIG. 5 is a cross-sectional view of the laminated butterfly wing 10 according to a first embodiment of the present invention.

FIG. 6 is a cross-sectional view of a laminated butterfly wing 50 according to an alternative embodiment of the present invention.

### BEST MODE OF CARRYING OUT THE INVENTION

The present invention is a butterfly wing lamination process for the purpose of strengthening and/or preserving butterfly wings to facilitate their use in the design and construction of decorative items, such as jewelry, accessories, gift items, other crafts, and objects of art.

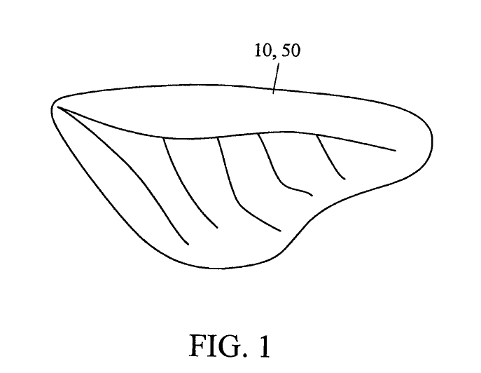

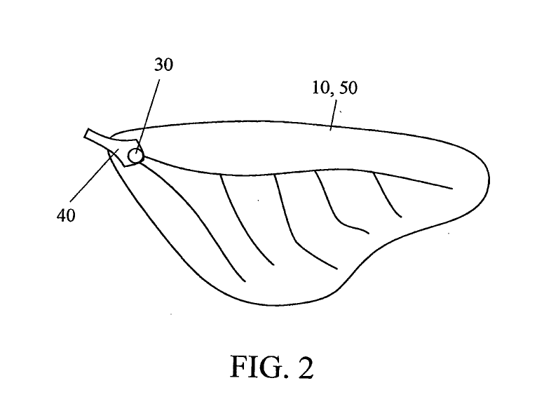

FIG. 1 is a top perspective view of a laminated butterfly wing 10, 50 in accordance with both embodiments of the present invention. FIG. 2 is a top perspective view of a laminated butterfly wing 10, 50 used in the creation of jewelry.

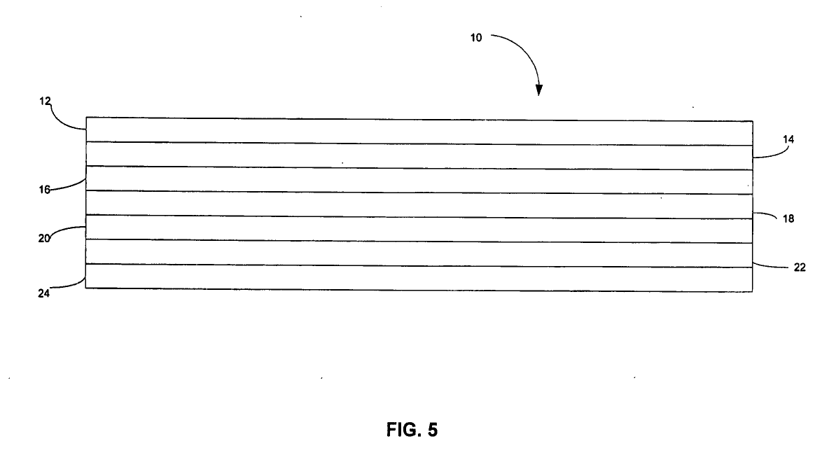

FIG. 5 is a cross-sectional view of a butterfly wing 10 according to a first embodiment of the present invention showing the seven laminated layers created by the process. The process for applying the seven laminated layers as in FIG. 5 typically includes a series of fourteen steps and the use of four materials/mixtures as will be described.

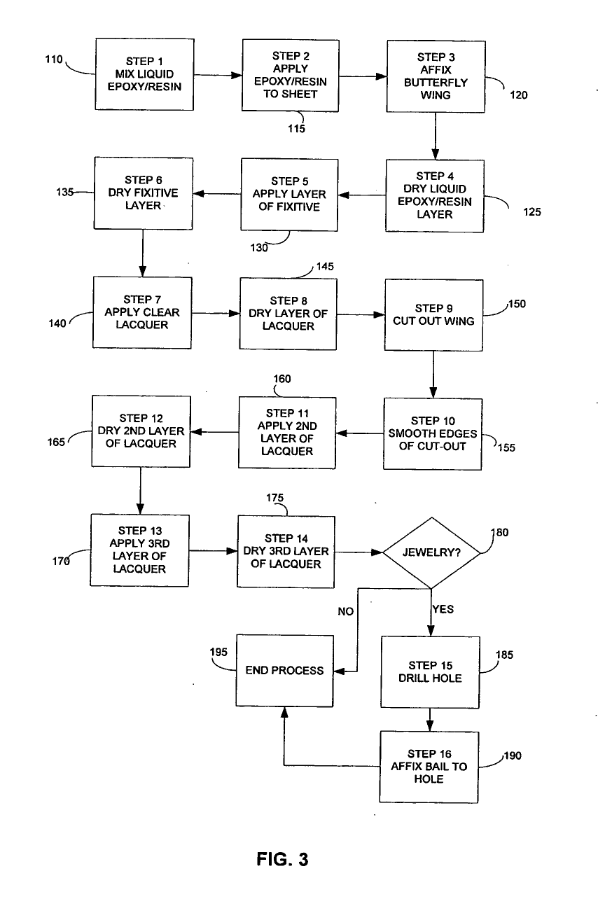

FIG. 3 is a flow diagram of the laminated butterfly wing process of the present invention. The first process step of the preferred embodiment of the present invention is the mixing of a liquid epoxy resin at Step 110. The liquid epoxy resin is preferably a two-part mixture including a resin and a hardener. An example of a suitable two-part mixture is the Castin' Craft Clear Liquid Plastic Casting Resin commercially available from ETI of Fields Landing, Calif. However, other resin/hardener mixtures possessing, for example, similar degrees of clarity and rigidity may also be utilized.

At Step 115, the second process step is the application of a layer 14 of the liquid epoxy resin to a sheet of thin smooth material, such as commercially-available polyester film or Mylar® 12. The epoxy resin layer 14 is preferably applied to the sheet 12 by first pouring an appropriate amount of the liquid onto the sheet 12 (which is preferably lying flat on a horizontal surface) and then spreading the liquid to a substantially uniform thickness using a commercially available leveling stick.

The third process step is the affixing of an actual butterfly wing 16 to the layer 14 of liquid epoxy resin on the sheet 12, at Step 120. The butterfly wing 16 is preferably laid upon the layer 14 of epoxy resin, and gently tamped down, just as the layer 14 begins to dry. This step serves to seal one side of the wing 16 behind the epoxy resin layer 14 and sheet 12.

At Step 125, the fourth process step is the drying of the layer 14 of liquid epoxy resin. In general, a period of eight to twelve hours is allowed to pass in order to provide sufficient time for the layer 14 to dry completely. However, a longer or shorter period of time may be required for materials other than the Castin' Craft Clear Liquid Plastic Casting Resin.

The fifth process step is the application of a layer 18 of fixative to the exposed side of the butterfly wing 16, at Step 130. The fixative layer 18 is preferably sprayed onto the exposed side of the wing 16 so as to not disturb the wing's color and pattern producing “scales”. The fixative layer 18 serves to hold the scales in position during the balance of the lamination process. An example of a suitable fixative is the Paul Mitchell Finish Super Clean Spray® commercially available from John Paul Mitchell Systems of Beverly Hills, Calif. However, other fixatives possessing, for example, similar degrees of clarity and bonding strength may also be utilized.

At Step 135, the sixth process step is the drying of the fixative layer 18. In general, a period of twenty minutes is allowed to pass in order to provide sufficient time for the layer 18 to dry completely. However, a longer or shorter period of time may be required for materials other than the Paul Mitchell Finish Super Clean Spray®.

The seventh process step is the application of a first finish coat 20 of clear lacquer/resin over the fixative layer 18, at Step 140. The clear lacquer/resin layer 20 is preferably applied using a commercially available paint brush. The clear a polyester film such as Mylar® layer 20 may be applied over the entire butterfly wing 16, or it may be applied only to certain areas of the wing 16. An example of a suitable clear lacquer/resin is the Treasure Crystal Cote®, an oil-based craft coating commercially available from Plaid Enterprises of Norcross, Ga. However, other clear lacquer/resins possessing, for example, similar degrees of clarity and durability may also be utilized.

At Step 145, the eighth process step is the drying of the first finish coat 20 of clear lacquer/resin. In general, a period of twelve hours is allowed to pass in order to provide sufficient time for the layer 20 to dry completely. However, a longer or shorter period of time may be required for materials other than the Treasure Crystal Cote®.

The ninth process step is cutting along the outer perimeter of the butterfly wing 16 to separate the wing 16 from the remainder of the sheet 12, at Step 150. This step is preferably accomplished via the use of a commercially available pair of shears.

At Step 155, the tenth process step is the smoothing of the edges of the cut-out, partially laminated butterfly wing 16 (i.e. including the sheet 12, the layer of epoxy resin 14, the layer of fixative 18, and the first finish coat of lacquer/resin 20). This step is preferably accomplished via the use of a commercially available sanding device such as a Dremel® rotary tool equipped with an appropriate fine grit sanding head.

The eleventh process step is the application of a second finish coat 22 of clear lacquer/resin over the first finish coat 20, at Step 160. As in Step 140 above, the clear lacquer/resin finish coat 22 is preferably applied using a commercially available paint brush. Once again, an example of a suitable clear lacquer/resin is the Treasure Crystal Cote, however, other clear lacquer/resins possessing similar characteristics may also be utilized.

At Step 165, the twelfth process step is the drying of the second finish coat 22 of clear lacquer/resin. In general, a period of twelve hours is allowed to pass in order to provide sufficient time for the finish coat 22 to dry completely. However, a longer or shorter period of time may be required for materials other than the Treasure Crystal Cote®.

The thirteenth process step is the application of a third finish coat 24 of clear lacquer/resin over the second finish coat 22, at Step 170. As in Steps 140 and 160 above, the clear lacquer/resin finish coat 24 is preferably applied using a commercially available paint brush. Once again, an example of a suitable clear lacquer/resin is the Treasure Crystal Cote®, however, other clear lacquer/resins possessing similar characteristics may also be utilized.

At Step 175, the fourteenth process step is the drying of the third finish coat 24 of clear lacquer/resin. In general, a period of twelve hours is allowed to pass in order to provide sufficient time for the finish coat 24 to dry completely. However, a longer or shorter period of time may be required for materials other than the Treasure Crystal Cote®.

If, at 180, it is determined that the butterfly wing will be used in a piece of jewelry, the process continues at Step 185. Otherwise the process ends at 195.

If the butterfly wing is to be used in jewelry, at Step 185, the fifteenth process step is the drilling of a hole 30 (see FIG. 2) through one end of the laminated butterfly wing 10. This step is preferably accomplished via the use of a commercially available drilling unit such as a Dremel® rotary tool equipped with an appropriate drill bit. After Step 190, the process is complete at 195.

At Step 190, the sixteenth, and final, process step is the affixing of a commercially-available bail 40 (see again FIG. 2) to the hole 30 in the laminated butterfly wing 10. The bail 30 facilitates the connection of the laminated butterfly wing 10 to all manner of jewelry mounts such as earrings, necklaces, wine glass charms, etc. The process is then complete at Step 195.

An alternative embodiment of the present invention is preferably used to strengthen and preserve extremely fragile butterfly wings (i.e. those with scales that are very, very delicate and removed by the lightest of contact).

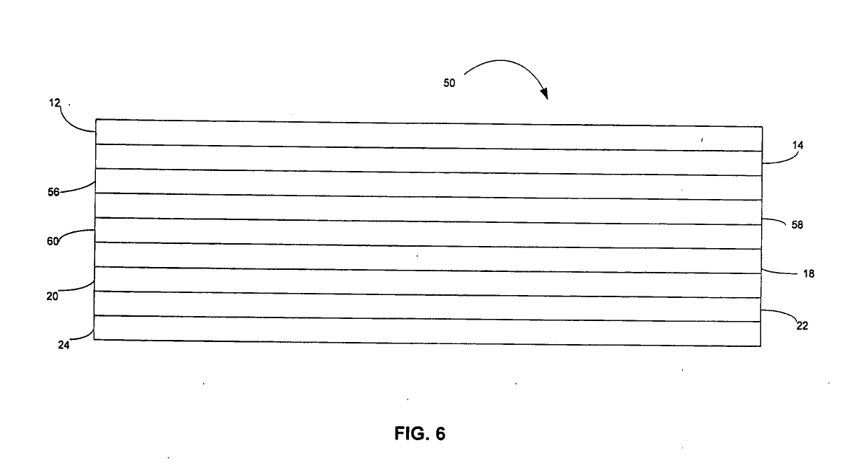

FIG. 6 is a cross-sectional view of a butterfly wing 50 according to this second embodiment showing nine laminated layers created by an alternate process. This process for constructing this second embodiment typically includes a series of sixteen steps and the use of five materials/mixtures.

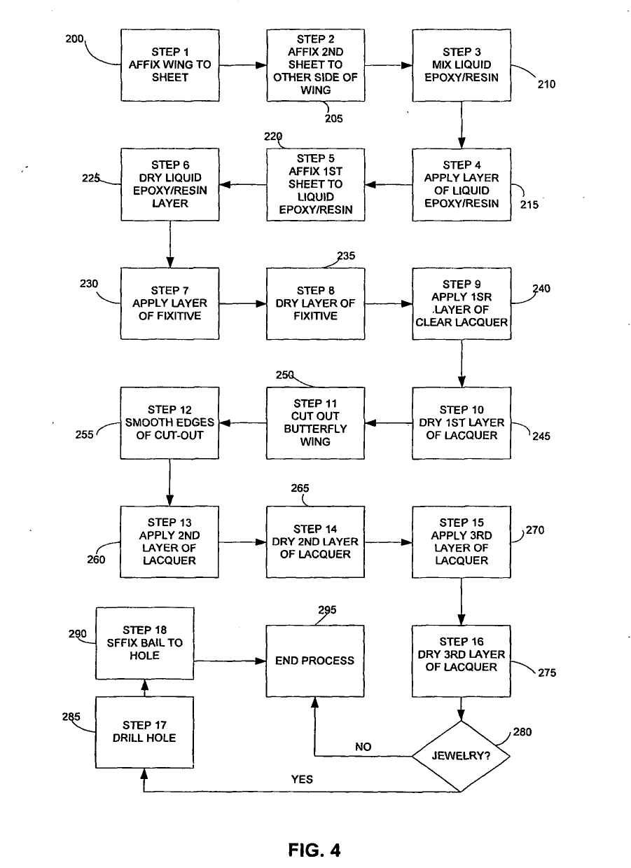

FIG. 4 is a flow diagram of the laminated butterfly wing process for forming the embodiment of FIG. 6 according to the present invention, this alternate process being especially suited for preserving extremely fragile wings. At Step 200, the first process step of the alternative embodiment of the present invention is the affixing of an actual butterfly wing 58 to a first sheet of commercially-available, self-adhesive, ultra-thin material 56, such as Mylar® or other polyester film. The butterfly wing 58 is preferably laid upon the first sheet 56 and gently tamped down. This step serves to seal one side of the wing 58 behind the first sheet 56.

The second process step is the affixing of a second sheet of commercially-available, self-adhesive, ultra-thin material 60, such as Mylar® to the exposed side of the butterfly wing 58, at Step 205. The second sheet 60 is preferably affixed onto the exposed side of the wing 16 so as to not disturb the wing's color and pattern producing “scales”. The sheets 56, 60 serve to seal and hold the scales in position during the balance of the lamination process.

At Step 210, the third process step is the mixing of a liquid epoxy resin. The liquid epoxy resin is preferably a two-part mixture including a resin and a hardener. An example of a suitable two-part mixture is the Castin' Craft Clear Liquid Plastic Casting Resin® commercially available from ETI of Fields Landing, Calif. However, other resin/hardener mixtures possessing, for example, similar degrees of clarity and rigidity may also be utilized.

At Step 215, the fourth process step is the application of a layer 14 of the liquid epoxy resin to a sheet of thin smooth material 12, such as commercially-available Mylar® or other polyester film. The liquid epoxy resin layer 14 is preferably applied to the sheet 12 by first pouring an appropriate amount of the liquid onto the sheet 12 (which is preferably lying flat on a horizontal surface) and then spreading the liquid to a substantially uniform thickness using a commercially available leveling stick.

The fifth process step is the affixing of the first ultra-thin sheet 56 to the layer 14 of liquid epoxy resin on the sheet 12, at Step 220. This step also serves to affix the wing 58 and second ultra-thin sheet 60 to the layer 14 of liquid epoxy resin. The sheet 56 is preferably laid upon the layer 14 of epoxy resin, and gently tamped down, just as the layer 14 begins to dry.

The sixth process step is the drying of the layer 14 of liquid epoxy resin, at Step 225. In general, a period of eight to twelve hours is allowed to pass in order to provide sufficient time for the layer 14 to dry completely. However, a longer or shorter period of time may be required for materials other than the Castin' Craft Clear Liquid Plastic Casting Resin®.

At Step 230, the seventh process step is the application of a layer 18 of fixative to the second ultra-thin sheet 60. The fixative layer 18 is preferably sprayed onto the sheet 60. An example of a suitable fixative is the Paul Mitchell Finish Super Clean Spray commercially available from John Paul Mitchell Systems of Beverly Hills, Calif. However, other fixatives possessing, for example, similar degrees of clarity and bonding strength may also be utilized.

The eighth process step is the drying of the fixative layer 18, at Step 235. In general, a period of twenty minutes is allowed to pass in order to provide sufficient time for the layer 18 to dry completely. However, a longer or shorter period of time may be required for materials other than the Paul Mitchell Finish Super Clean Spray®.

At Step 240, the ninth process step is the application of a first finish coat 20 of clear lacquer/resin over the entire fixative layer 18. The clear lacquer/resin finish coat 20 is preferably applied using a commercially available paint brush. An example of a suitable clear lacquer/resin is the Treasure Crystal Cote® commercially available from Plaid Enterprises of Norcross, Ga. However, other clear lacquer/resins possessing, for example, similar degrees of clarity and durability may also be utilized.

The tenth process step is the drying of the first finish coat 20 of clear lacquer/resin, at Step 245. In general, a period of twelve hours is allowed to pass in order to provide sufficient time for the finish coat 20 to dry completely. However, a longer or shorter period of time may be required for materials other than the Treasure Crystal Cote®.

At Step 250, the eleventh process step is cutting along the outer perimeter of the butterfly wing 58 to separate the wing 58 from the remainder of the thin sheets 12, 56, 60. This step is preferably accomplished via the use of a commercially available pair of shears.

At Step 255, the twelfth process step is the smoothing of the edges of the cut-out, partially laminated butterfly wing 58 (i.e. including the Mylar® sheets 12, 56, 60, the layer of epoxy resin 14, the layer of fixative 18, and the first finish coat of lacquer/resin 20). This step is preferably accomplished via the use of a commercially available sanding device such as a Dremel® rotary tool equipped with an appropriate, fine grit sanding head.

Steps 260 through 275 of this alternative embodiment are, respectively, exact duplicates of steps 160 through 175 of the preferred embodiment described above.

If, at 280, it is determined that the butterfly wing will be used in a piece of jewelry, the process continues at Step 285. Otherwise the process ends at 295.

If the butterfly wing is to be used in jewelry, at Step 285, the seventeenth process step is the drilling of a hole 30 (see FIG. 2) through one end of the laminated butterfly wing 50. This step is preferably accomplished via the use of a commercially available drilling unit such as a Dremel® rotary tool equipped with an appropriate drill bit.

At Step 290, the eighteenth, and final, process step is the affixing of a commercially-available bail 40 (see again FIG. 2) to the hole 30 in the laminated butterfly wing 50. The bail 30 facilitates the connection of the laminated butterfly wing 50 to all manner of jewelry mounts such as earrings, necklaces, wine glass charms, etc. The process is then complete at 295.

As is readily evident, the above processes for the lamination of butterfly wings use strong, durable, lightweight materials and may be readily and economically performed to provide for repeated use. When utilized in conjunction with a butterfly wing, the process results in a multi-layered lamination that strengthens and preserves the wing's naturally occurring vibrant colors and intricate patterns over time, and facilitates its use in a wide variety of jewelry, accessories, crafts, gift items, and objects of art. The resulting laminated butterfly wings maintain their distinct beauty, yet are weatherproof, durable, and may be easily cleaned with a damp rag. Thus, they may be used in any manner of decorative items, such as jewelry, including earrings, necklaces, bracelets, and the like; hair and clothing adornments; and stem ware charms. They can be mounted on a pin in a natural flying position, added to a decorative fresh or artificial flower arrangement, or displayed alone or in combination with other butterfly wings and/or other art to create a unique object of art. Because the natural beauty of the delicate butterfly wing is strengthened and preserved, it may be used in any number of decorative or artistic displays.

Of course, it would be obvious to one skilled in the art, to apply the butterfly wing lamination process and method of use of the present invention to other insects with distinct visual characteristics. For example, the present invention has been applied to the wings of moths, dragon flies, cicada, grasshoppers, beetles, and dobson flies.

### INDUSTRIAL APPLICABILITY

Butterfly wings are a beautiful intricate creation of nature and as such, are pleasing to the eye in all manner of display. Butterfly wings can be used to create jewelry, accessories, gift items, crafts, and objects of art. However, butterfly wings are extremely fragile and must be preserved to retain their natural beauty. Prior methods of preservation include crude forms, such as pressing between waxed paper to more advanced methods, such as encasing in wax or airtight acrylic frames. These existing methods are unsuitable for making jewelry, and yet there is a significant commercial demand for jewelry incorporating properly-preserved butterfly wings. The multi-layer lamination process of the present invention uses strong, durable, lightweight materials that strengthen and preserve the natural colors and patterns of the butterfly wings and allow the wings to be used in the creations of beautiful jewelry, craft, accessory, and other gift item designs, and objects of art.

Having now filly set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1-6. (canceled)

7. A lamination process for extremely fragile butterfly wings, comprising the steps of:
affixing a natural butterfly wing to a first sheet of self-adhesive ultra-thin smooth material;
affixing a second sheet of self-adhesive ultra-thin smooth material to the exposed side of said butterfly wing;
mixing a liquid epoxy resin;
applying a layer of said liquid epoxy resin to a sheet of thin smooth material;
affixing said first ultra-thin sheet to said layer of liquid epoxy resin on said sheet;
allowing said layer of liquid epoxy resin to dry;
applying a layer of fixative to said second ultra-thin sheet;
allowing said layer of fixative to dry;
applying a first layer of clear lacquer/resin over said layer of fixative;
allowing said first layer of lacquer/resin to dry;
cutting along an outer perimeter of said butterfly wing to separate said wing from a remainder of said sheet;
smoothing said perimeter of said cut-out butterfly wing;
applying a second layer of clear lacquer/resin over said first layer of clear lacquer/resin;
allowing said second layer of lacquer/resin to dry;
applying a third layer of clear lacquer/resin over said second layer of clear lacquer/resin; and
allowing said third layer of lacquer/resin to dry;
wherein a preserved laminated butterfly wing suitable for use in all manner of decorative design results.

8. The lamination process for extremely fragile butterfly wings according to claim 7, further comprising the steps of:
drilling a hole through an end of said butterfly wing, and
affixing a bail to said hole,
wherein a preserved laminated butterfly wing suitable for use in all manner of jewelry results.

9. The lamination process for extremely fragile butterfly wings according to claim 7, wherein said sheet of thin smooth material is a polyester film such as Mylar®.

10-12. (canceled)

13. A lamination process for insect wings, comprising the steps of:
mixing a liquid epoxy resin;
applying a layer of said liquid epoxy resin to a sheet of thin smooth material;
affixing an insect wing to said layer of liquid epoxy resin on said sheet;
allowing said layer of liquid epoxy resin to dry;
applying a layer of fixative to an exposed side of said insect wing;
allowing said layer of fixative to dry;
applying a first layer of clear lacquer/resin over said layer of fixative;
allowing said first layer of lacquer/resin to dry;
cutting along an outer perimeter of said insect wing to separate said wing from a remainder of said sheet;
smoothing said perimeter of said cut-out insect wing;
applying a second layer of clear lacquer/resin over said first layer of clear lacquer/resin;
allowing said second layer of lacquer/resin to dry;
applying a third layer of clear lacquer/resin over said second layer of clear lacquer/resin; and
allowing said third layer of lacquer/resin to dry;
wherein a preserved laminated insect wing suitable for use in all manner of decorative design results.

14. The lamination process for insect wings according to claim 13, further comprising the steps of:
drilling a hole through an end of said insect wing, and
affixing a bail to said hole,
wherein a preserved laminated insect wing suitable for use in all manner of jewelry results.

15. The lamination process for insect wings according to claim 13, wherein said sheet of thin smooth material is a polyester film such as Mylar®.

16. A laminated insect wing, comprising:
a first layer of a sheet of thin smooth material;
a second layer of a liquid epoxy resin applied to said first layer;
a third layer of a natural insect wing affixed to said first and second layer combination;
a fourth layer of fixitive applied to the exposed side of said insect wing;
a fifth layer of a first application of clear lacquer applied to said fourth layer;
a sixth layer of a second application of clear lacquer applied to said fifth layer; and
a seventh layer of a third application of clear lacquer applied to said sixth layer.

17. A lamination process for insect wings, comprising the steps of:
applying a layer of liquid epoxy resin to a sheet of smooth material;
affixing an insect wing to said layer of liquid epoxy resin on said sheet;
allowing said layer of liquid epoxy resin to dry;
applying a layer of fixative to an exposed side of said insect wing and allowing to dry;
applying a first finish coat over said layer of fixative;
allowing said first finish coat to dry;
cutting along an outer perimeter of said insect wing to separate said wing from a remainder of said sheet;
smoothing said perimeter of said cut-out insect wing;
wherein the resulting multi-layer laminated insect wing is suitable for use in all manner of decorative design results.

18. The lamination process for insect wings according to claim 17, further comprising the steps of;
applying a second finish coat over said first finish coat;
allowing said second finish coat to dry.

19. The lamination process for insect wings according to claim 17, further comprising the steps of
applying a third finish coat over said second finish coat; and
allowing said third finish coat of lacquer/resin to dry.

20. The lamination process for insect wings according to claim 17, further comprising the steps of:
drilling a hole through an end of said insect wing, and
affixing a bail to said hole.
